(19) United States
(12) Patent Application Publication
(10) Pub. No.: US 2021/0103833 A1
(43) Pub. Date: Apr. 8, 2021

(54) WORKFLOW SUPPORT APPARATUS, WORKFLOW SUPPORT SYSTEM, AND NON-TRANSITORY COMPUTER READABLE MEDIUM STORING PROGRAM

(71) Applicant: FUJI XEROX CO., LTD., Tokyo (JP)

(72) Inventor: Aoi TANIGUCHI, Kanagawa (JP)

(73) Assignee: FUJI XEROX CO., LTD., Tokyo (JP)

(21) Appl. No.: 16/885,280

(22) Filed: May 28, 2020

(30) Foreign Application Priority Data
Oct. 2, 2019 (JP) 2019-182082

(51) Int. Cl. G06N 5/04; G06F 16/93

(52) U.S. Cl. CPC G06N 5/04; G06F 16/93

(57) ABSTRACT

A workflow support apparatus includes a storage location selection unit that compares a trend of a history of executing a workflow with a trend of a currently running workflow and selects a storage location of a document, and a presentation unit that presents information on the storage location of the document selected by the storage location selection unit.

### CROSS-REFERENCE TO RELATED APPLICATIONS

This application is based on and claims priority under 35 USC 119 from Japanese Patent Application No. 2019-182082 filed Oct. 2, 2019.

### BACKGROUND

### (i) Technical Field

The present invention relates to a workflow support apparatus, a workflow support system, and a non-transitory computer readable medium storing a program.

### (ii) Related Art

JP2006-163544A discloses a document management system that shares documents, the document management system including a document registering system that registers the document, a document managing system that manages a document list, a document input apparatus that inputs the document, and a file server that is installed to store the document, in which an image form registering unit that registers an image form and a form analysis unit that detects that any image form matches the registered form are provided, the document is divided according to the form when the detection is made that the target image matches the image form registered in advance, and processing is performed for each document in accordance with a predetermined procedure set in advance for the form.

JP2006-243832A discloses a workflow search system that supports a workflow in which a task configuration is dynamically changes, the workflow search system including a document database that stores a document attached to the workflow, a first similar document index unit that searches based on a similarity of the document, an access right management unit that manages a task configuration read access right of the workflow and an access right of the attachment document, a first extraction unit that extracts the document attached to the workflow specified by a user in a case of searching for the workflow, a second similar document index unit that searches the document database by using the document extracted by the extraction unit as a key, a second extraction unit that extracts the workflow having, as the attachment document, the document of a search result searched by the second similar document index unit, and a display unit that displays the workflow to which the task configuration read access right is permitted, regardless of the access right of the document of the search result.

### SUMMARY

Aspects of non-limiting embodiments of the present disclosure relate to a workflow support apparatus, a workflow support system, and a non-transitory computer readable medium storing a program that can indicate a workflow instance to which a document is to be attached.

A workflow refers to a flow of a series of tasks in an organization. A workflow instance refers to a flow of an actual task created using the defined workflow as a template.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a workflow support apparatus including a storage location selection unit that compares a trend of a history of executing a workflow with a trend of a currently running workflow and selects a storage location of a document, and a presentation unit that presents information on the storage location of the document selected by the storage location selection unit.

### BRIEF DESCRIPTION OF THE DRAWINGS

Exemplary embodiment(s) of the present invention will be described in detail based on the following figures, wherein:

FIG. 1 is a block diagram showing entire workflow support system according to an exemplary embodiment of the invention;

FIG. 2 is a block diagram showing hardware of a workflow support apparatus according to the exemplary embodiment of the invention;

FIG. 3 is a block diagram showing a function of the workflow support apparatus according to the exemplary embodiment of the invention;

FIG. 4 is a diagram for explaining a workflow definition in the workflow support apparatus according to the exemplary embodiment of the invention;

FIG. 5 is a diagram for explaining calculation of a certainty factor based on a document classification prediction in the workflow support apparatus according to the exemplary embodiment of the invention;

FIG. 6 is a diagram for explaining calculation of a certainty factor based on trend information of a workflow instance in the workflow support apparatus according to the exemplary embodiment of the invention;

FIG. 7 is a flowchart showing a flow of advance preparation processing in the workflow support apparatus according to the exemplary embodiment of the invention; and

FIG. 8 is a flowchart for searching for the workflow instance for an attachment document in the workflow support apparatus according to the exemplary embodiment of the invention.

### DETAILED DESCRIPTION

An exemplary embodiment of the invention will be described in detail with reference to the accompanying drawings.

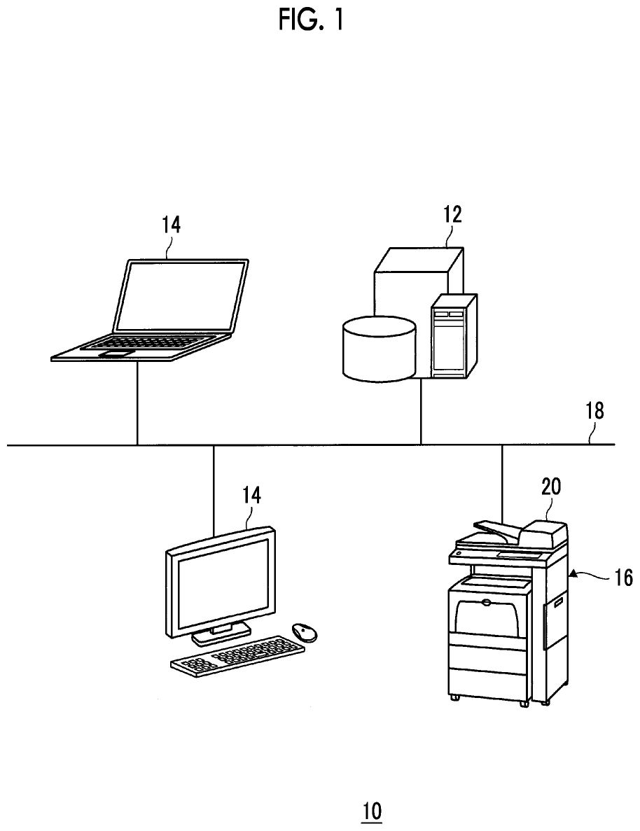

FIG. 1 shows entire workflow support system. 10 according to the exemplary embodiment of the invention.

In the workflow support system 10, a server 12 configuring a workflow support apparatus, personal computers 14, 14, and an image forming apparatus 16 are connected to each other via a network 18. The image forming apparatus 16 is a so-called multifunction machine having a print function, a facsimile function, a scan function, and is provided with an image reading device 20 having an automatic document feeder. The network 18 may be a local area network or the Internet.

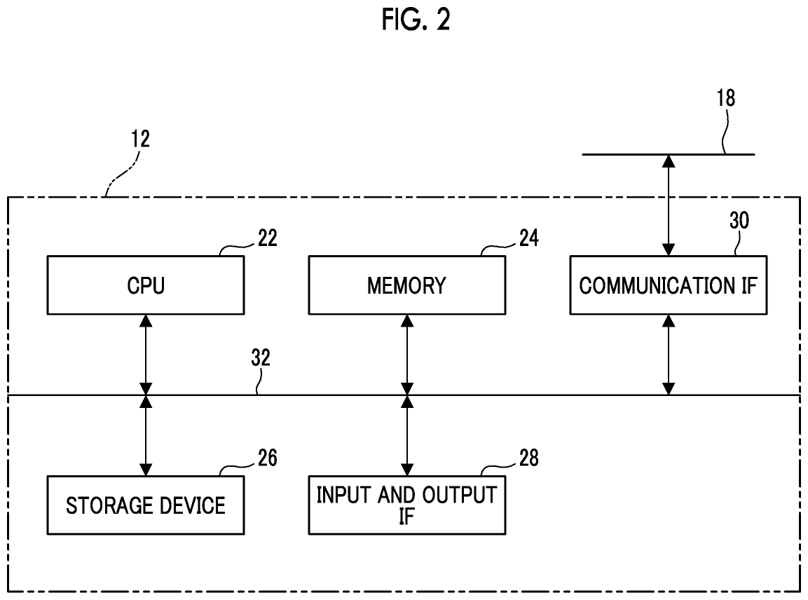

FIG. 2 is a block diagram showing hardware of the server 12.

The server 12 includes a CPU 22, a memory 24, a storage device 26, an input and output interface 28, and a communication interface 30, and the CPU 22, the memory 24, the storage device 26, the input and output interface 28, and the communication interface 30 are connected to each other via a bus 32.

The CPU 22 executes predetermined processing based on a control program stored in the memory 24. The storage device 26 is configured by, for example, a hard disk, and stores the necessary software or data. The storage device 26 stores a workflow database. The workflow database holds information such as execution date and time, executor, information on an attachment document, connection between nodes (execution processing units), a current state of the workflow. The input and output interface 28 is connected to a display or a keyboard (not shown), and inputs and outputs data to and from the display or the keyboard. Data is input and output to and from the communication interface 30 via the network 18 described above.

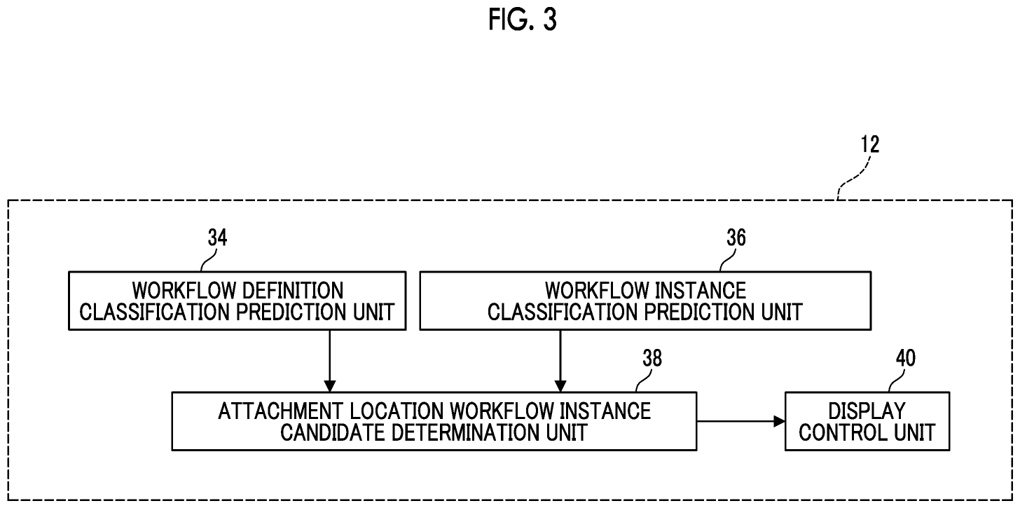

FIG. 3 is a block diagram showing a function of the workflow support apparatus 10 according to the exemplary embodiment of the invention.

The workflow support apparatus 10 includes a workflow definition classification prediction unit 34, a workflow instance classification prediction unit 36, an attachment location workflow instance candidate determination unit 38, and a display control unit 40.

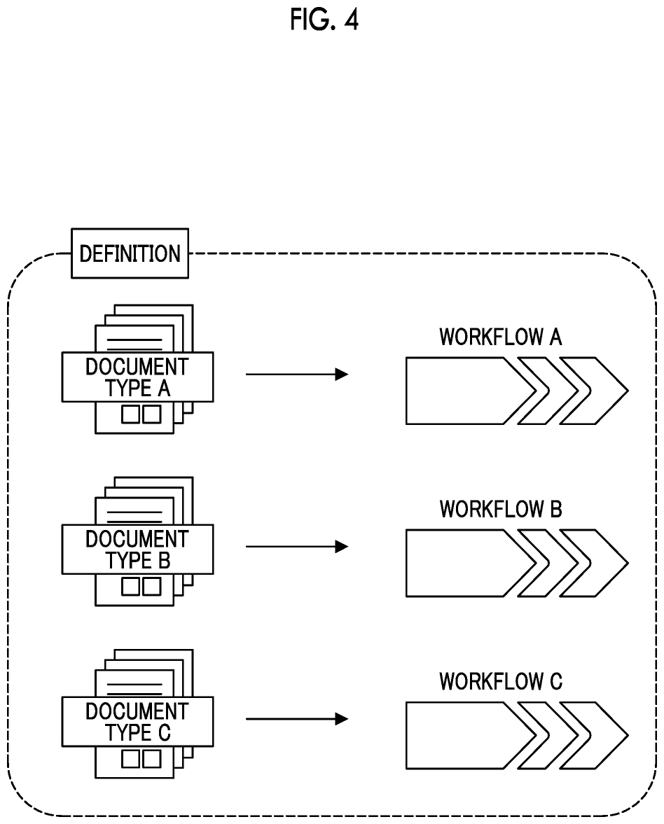

A workflow definition is an electronic definition of nodes necessary for executing a task, and a flow (an order) of the nodes. With regard to the workflow definition, the flow may be explicitly defined, or the flow may not have an explicit order (for example, a system having no order such as process management). As shown in FIG. 4, in the workflow, for example, transportation expenses settlement, goods purchase, attendance approval are defined for each, and a report for each workflow is used when the document is attached, regardless of whether the form is fixed or irregular. The workflow definition classification prediction unit 36 predicts what workflow definition the document (hereinafter, referred to as an attachment document) is to be attached. That is, the workflow definition classification prediction unit 36 inspects the contents of the document using a known natural language processing technique, and predicts the determined document type.

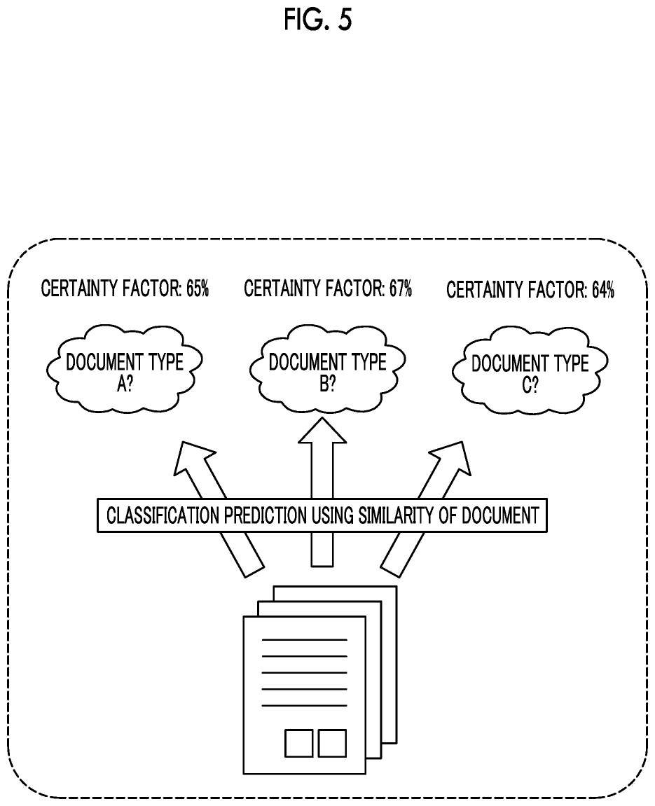

The workflow definition classification prediction unit configures a workflow definition selection unit, and predicts a workflow definition classification using a similarity of the attachment document as shown in FIG. 5. Specifically, the workflow definition classification prediction unit 36 predicts the workflow definition classification by using a method shown in an example below.

(1) The past attached document is read in advance by, for example, the image reading device 20 of the image forming apparatus 16 described above, sent to the server 12, and the attachment document read by the server 12 is analyzed. In the analysis, a text string of the attachment document, an arrangement position of the text string, the text size of the text string, the color of the text string, and the like are extracted, the extracted analysis results are stored, and classification learning is performed by using an identification (ID; a code for identification) of the workflow definition as a teacher.

(2) The input attachment document is similarly analyzed, and the classification prediction of the workflow definition ID is performed by using the result learned in (1). That is, the similarity between the attachment document learned in (1) and the input attachment document is determined.

(3) The attachment document similarity determination (the same as the workflow definition determination) performed in (2) is adopted as certainty factors of the workflow definition. Here, a certainty factor of a workflow definition A is f_{A} and a certainty factor of a workflow definition B is f_{B}.

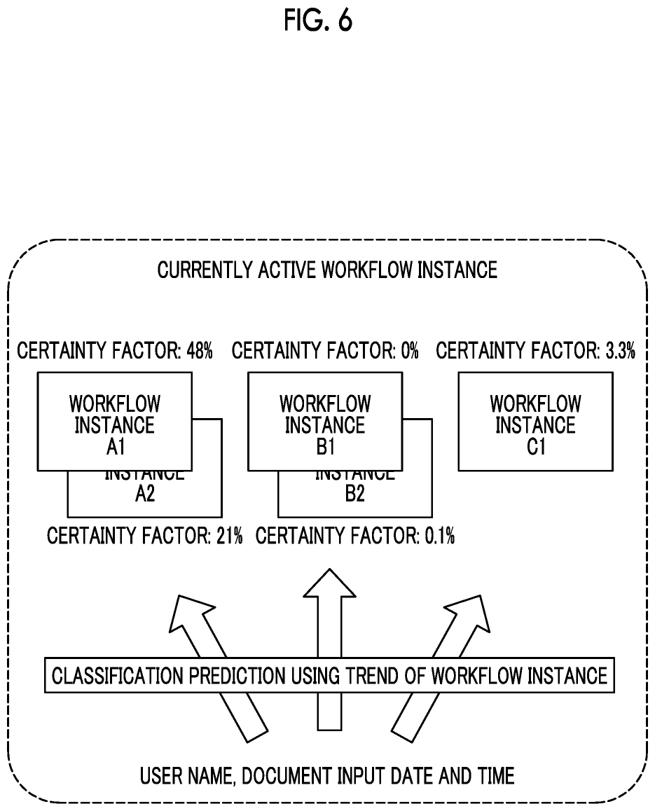

The workflow instance classification prediction unit 36 configures a workflow instance selection unit, and classifies the workflow corresponding to the attachment document using a trend of a workflow instance for each workflow definition as shown in FIG. 6. Specifically, the workflow definition classification prediction unit 36 predicts the workflow instance classification by using a method shown in an example below.

(1) For each scale for evaluating the trend for each workflow definition (for example, the time from when the attachment document is visible in each node of the workflow until the document attachment ends (referred to as residence time), the number of the workflow instances executed within a predetermined time period in each node of the workflow (referred to as the number of residence instances), the residence time of an each node executor for each node, and the number of residence instances of each node executor for each node), an average value and a standard deviation (σ) is obtained from history information of the past workflow instance.

(2) For each workflow instance running when inputting the document (having an access right of an input user), each evaluation scale described above is evaluated by using time when the document is input (for example, in a case where the document is attached to the target workflow instance at the current time, how long waiting time for attachment occurs, and how many instances residue in the next node).

(3) For each evaluation scale, a value is calculated by multiplying a probability density of the normal distribution with respect to 1 of the value calculated in (2) by √(2π)σ.

The reason for multiplying by √(2π)σ is to set the probability density to 1 in a case where the center of the normal distribution is an average value.

Probability density f(x)=exp[−(x?μ)²/2σ²]

x: each evaluation value calculated in (2)

μ: average value of each evaluation value calculated in (1)

σ: standard deviation calculated in (1)

(4) The percentage of the value obtained by multiplying all of the probability densities of the evaluation scales calculated in (3) is defined as the certainty factor of the “trend of workflow instance information”.

The certainty factor is calculated as follows, for example.

Certainty factor f_{A1} of classification prediction of workflow instance A1=f(x_{A1#1})·f(x_{A1#2}) . . . f(x_{A1#L})

Certainty factor f_{A2} of classification prediction of workflow instance A2=f(x_{A2#1})·f(x_{A2#2}) . . . f(x_{A2#L}) . . .

Certainty factor f_{B1} of classification prediction of workflow instance B1=f(x_{B1#1})·f(x_{B1#2}) . . . f(x_{B1#L}) . . .

Certainty factor f_{MN} of classification prediction of workflow instance MN=f(x_{NM#1})·f(x_{NM#2}) . . . f(x_{MN#L})

Here, L, M, and N are as follows.

L: the total number of evaluation scale

M: workflow definition (that is currently running and accessible to user) number

N: instance (that is currently running and accessible to user) number of workflow definition M

With reference to FIG. 3 again, the attachment location workflow instance candidate determination unit 38 obtains the final certainty factor of the workflow instance candidate from the workflow definition classification predicted by the workflow definition classification prediction unit 34 and the workflow instance classification predicted by the workflow instance classification prediction unit 36.

The final certainty factors of the workflow instance candidates are as follows, for example.

Certainty factor F_{A1} of workflow instance A1=f_{A}·f_{A1}

Certainty factor F_{A2} of workflow instance A2=f_{A}·f_{A2} . . .

Certainty factor F_{B1} of workflow instance B1=f_{B}·f_{B1} . . .

Certainty factor F_{MN} of workflow instance MN=f_{M}·f_{MN}

The display control unit 40 configures a workflow instance presentation unit, generates a display screen of the workflow instance candidate to which the document is to be attached based on the final certainty factor determined by the attachment location workflow instance candidate determination unit 28, and sends the display screen to the personal computers 14, 14 described above. The workflow instance candidate may be displayed in descending order of the certainty factor, or may be displayed with the obtained certainty factor.

Hereinafter, a processing flow of the workflow instance classification prediction in the server 12 described above will be described with the exemplary embodiment.

First, environmental information will be described.

Here, an applicant who inputs the document is a user A, and an approver who performs approval or rejection is a superior B. The date and time of document input is set to 10:00:00 am on Mar. 25, 2019.

The defined workflow is as follows.

Workflow Definition A:

For example, the workflow is for transportation expenses settlement. A node 1 is a draft, and the applicant makes an entry of the approver or application information. A node 2 is, for example, document attachment such as a receipt, and is performed by the applicant. A node 3 is approval or rejection, and is performed by approver.

Workflow Definition B:

For example, the workflow is for goods purchase. A node 1 is a draft, and the applicant makes an entry of the approver or settlement application information. A node 2 is, for example, document attachment such as a written estimate, and is performed by the applicant. A node 3 is approval or rejection, and is performed by approver.

Workflow Definition C:

For example, the workflow is for attendance approval. A node 1 is a draft, and the applicant makes an entry of the approver or application information. Anode 2 is, for example, document attachment such as a delay certificate, and is performed by the applicant. Anode 3 is approval or rejection, and is performed by approver.

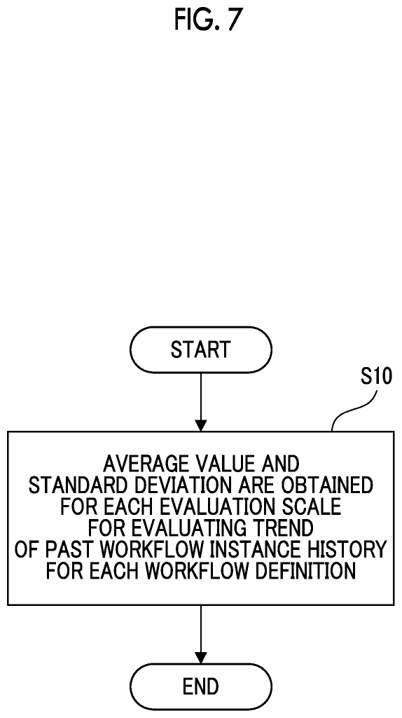

FIG. 7 shows a flowchart for advance preparation.

In step S10, the trend of the past workflow instance history is evaluated for each workflow definition. Then, an average value and a standard deviation is obtained for each evaluation scale for evaluating the trend of the workflow instance history.

The evaluation scale is set as follows, for example.

Evaluation scale 1: residence time of the node 1 (time from when the user A prepares a draft until the document is attached)

Evaluation scale 2: the number of residence instances of the node 3 (the number of the workflow instances that the superior B approves or rejects in one week)

For the sake of simplicity, a common evaluation scale are used for each workflow definition, but in general, the evaluation scale may be changed for each workflow definition.

The following is calculated from the environmental information.

Workflow Definition A:

Evaluation value 1: average 0.5 [hour], standard deviation 0.3 [hour]

Evaluation value 2: average 6.3, standard deviation 2.0

Workflow Definition B:

Evaluation value 1: average 72.0 [hours], standard deviation 5.0 [hours]

Evaluation value 2: average 3.2, standard deviation 0.5

Workflow Definition C:

Evaluation value 1: average 0.8 [hour], standard deviation 0.4 [hour]

Evaluation value 2: average 2.8, standard deviation 1.5

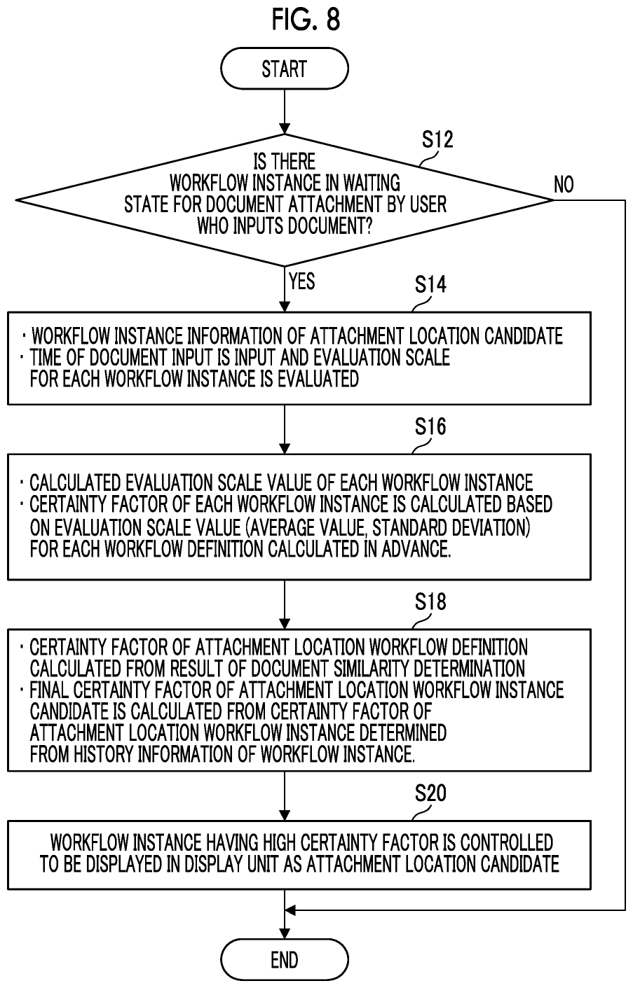

FIG. 8 shows a flowchart for determining what document is to be attached to the workflow instance currently trying to run.

In step S12, determination is made as to whether there is the workflow instance (the user A in the exemplary embodiment) in a waiting state for document attachment by user who inputs the document. Whether there is the workflow instance is in the waiting state for the document attachment is determined from the status information stored in the workflow database described above.

In step S12, in a case where determination is made that there is no workflow instance in the waiting state for the document attachment, the processing ends, and in a case where determination is made that there is the workflow instance in the waiting state for the document attachment, the processing proceeds to step S14.

In step S14, workflow instance information of the document attachment location candidates and the time of document input are input, and the evaluation scale of each workflow instance is evaluated.

In the exemplary embodiment, the workflow instance A1 belonging to the workflow definition A, the workflow instance A2 also belonging to the workflow definition A, the workflow instance A3 also belonging to the workflow definition A, the workflow instance B1 belonging to the workflow definition B, the workflow instance B2 also belonging to the workflow definition B, and the workflow instance C1 belonging to the workflow definition C are currently in the waiting state for the document attachment.

In the exemplary embodiment, the instance residence time of the evaluation scale 1 is, for example, 0.6 hour from the document attachment waiting start time (for example, 9:24:00 am on Mar. 25, 2019) to the current time (10:00:00 am on Mar. 25, 2019). Also, the number of residence instances of the node 3 of the evaluation scale 2 is the number of workflow instances that the superior B performs approval or rejection in the node 3 in one week.

In the exemplary embodiment, the evaluation scales 1 and 2 are evaluated as follows.

Workflow Instance A1:
Evaluation value 1: 0.6 [hour]
Evaluation value 2: 4

Workflow Instance A2
Evaluation value 1: 0.1 [hour]
Evaluation value 2: 4

Workflow Instance B1
Evaluation value 1: 10.5 [hours]
Evaluation value 2: 5

Workflow instance B2
Evaluation value 1: 68.0 [hours]
Evaluation value 2: 5

Workflow Instance C1
Evaluation value 1: 0.2 [hour]
Evaluation value 2: 6

In step S16, as described above, the certainty factor of each workflow instance is calculated from the calculated evaluation scale value of each workflow instance and the evaluation scale (an average value and a standard deviation) for each workflow definition that is calculated in advance.

In the exemplary embodiment, the certainty factor of each workflow instance is the probability density of the evaluation scale 2 multiplied by the probability density of the evaluation scale 1, and is calculated as follows.

Certainty factor of workflow instance A1=exp[−(0.6?0.5)2/2*(0.3)2]*exp[−(4?6.3)2/2*(2.0)2]=0.9459*0.5162=0.488(=48.8%)

Certainty factor of workflow instance A2=0.4111*0.5162=0.212(=21.2%)

Certainty factor of workflow instance B1=1.4053e−33*0.0015=2.15e−36(=2.15e−34%)

Certainty factor of workflow instance B2=0.726*0.0015=0.0011 (0.11%)

Certainty factor of workflow instance C1=0.3246*0.1027=0.0333 (3.33%)

* refers to a product.

In step S18, the final certainty factor of the workflow instance is calculated from the certainty factor of the attachment location workflow definition calculated from the result of the document similarity determination and the certainty factor of the attachment location workflow instance determined from the history information of the workflow instance.

The certainty factor of the attachment location workflow definition obtained from the result of the document similarity determination is obtained using the similarity between the document stored in past and the input document, as described with the workflow definition classification prediction unit 34 above.

In the exemplary embodiment, the following results are output.

Certainty factor that the document type is a receipt: 65% (that is, the certainty factor to be attached to any instance of workflow definition A)

Certainty factor that the document type is a written estimate: 67% (that is, the certainty factor to be attached to any instance of workflow definition B)

Certainty factor that the document type is delay certificate: 64% (the certainty factor to be attached to any instance of workflow definition C)

The certainty factor of the workflow instance is as described above, and the final certainty factor of the workflow instance is calculated as follows.

Certainty factor that the document type is a receipt and workflow instance is A1: 65%*48.8%=31.7%

Certainty factor that the document type is a receipt and workflow instance is A2: 65%*21.2%=13.8%

Certainty factor that the document type is a written estimate and the workflow instance is B1: 67%*2.15e−34%≈0%

Certainty factor that the document type is a written estimate and workflow instance is B2: 67%*0.11%=0.74%

Certainty factor that the document type is a delay certificate and workflow instance is C1: 64%*3.33%=2.13%

In step S20, the workflow instance having a high final certainty factor is controlled so as to be displayed in the display unit as an attachment location candidate. In the exemplary embodiment, the workflow instance A1 is displayed as the workflow instance having a highest certainty factor. As in the exemplary embodiment, even in a case where there is not much difference in the certainty factor of the workflow definition with respect to the attachment document, the workflow instance candidate of the document attachment location is indicated from the workflow definition.

In the exemplary embodiment, the workflow instance selection unit that selects the workflow instance to which the document is to be attached from the trend of history of the workflow instances stored in past is used in combination with the workflow definition selection unit that selects the workflow definition from the characteristic of the attachment document, however, the present invention is not limited thereto, only the workflow instance selection unit is provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A workflow support apparatus comprising:
a storage location selection unit that compares a trend of a history of executing a workflow with a trend of a currently running workflow and selects a storage location of a document; and
a presentation unit that presents information on the storage location of the document selected by the storage location selection unit.

2. The workflow support apparatus according to claim 1, further comprising:
a workflow definition selection unit that selects a workflow definition for a document to be input based on a relationship between the document and the workflow definition for the document,
wherein the presentation unit presents the information on the storage location of the document selected by the workflow definition selection unit and the storage location selection unit.

3. The workflow support apparatus according to claim 1,
wherein the storage location selection unit obtains and selects certainty factors of classification prediction for a plurality of the workflows.

4. The workflow support apparatus according to claim 2,
wherein the storage location selection unit obtains and selects certainty factors of classification prediction for a plurality of the workflows.

5. The workflow support apparatus according to claim 1,
wherein the storage location selection unit evaluates a trend for each workflow definition and selects the storage location of the document.

6. The workflow support apparatus according to claim 2,
wherein the storage location selection unit evaluates a trend for each workflow definition and selects the storage location of the document.

7. The workflow support apparatus according to claim 3,
wherein the storage location selection unit evaluates a trend for each workflow definition and selects the storage location of the document.

8. The workflow support apparatus according to claim 4,
wherein the storage location selection unit evaluates a trend for each workflow definition and selects the storage location of the document.

9. The workflow support apparatus according to claim 5,
wherein the storage location selection unit obtains an average value and a standard deviation of a past workflow for an evaluation scale for evaluating the trend for each workflow definition and a probability density from a value for the evaluation scale of the workflow in a case where the document is input and selects the storage location of the document.

10. The workflow support apparatus according to claim 6,
wherein the storage location selection unit obtains an average value and a standard deviation of a past workflow for an evaluation scale for evaluating the trend for each workflow definition and a probability density from a value for the evaluation scale of the workflow in a case where the document is input and selects the storage location of the document.

11. The workflow support apparatus according to claim 7,
wherein the storage location selection unit obtains an average value and a standard deviation of a past workflow for an evaluation scale for evaluating the trend for each workflow definition and a probability density from a value for the evaluation scale of the workflow in a case where the document is input and selects the storage location of the document.

12. The workflow support apparatus according to claim 8,
wherein the storage location selection unit obtains an average value and a standard deviation of a past workflow for an evaluation scale for evaluating the trend for each workflow definition and a probability density from a value for the evaluation scale of the workflow in a case where the document is input and selects the storage location of the document.

13. A workflow support system comprising:
a terminal apparatus including a document input unit that inputs a document to be attached to a workflow; and
a server that is connected to the terminal apparatus,
wherein the server includes
a storage location selection unit that compares a trend of a history of executing the workflow with a trend of a currently running workflow and selects a storage location of the document, and
a presentation unit that presents information on the storage location of the document selected by the storage location selection unit to the terminal apparatus.

14. A non-transitory computer readable medium storing
a program causing a computer to execute:
comparing a trend of a history of executing a workflow with a trend of a currently running workflow and selecting a storage location of a document, and
presenting information on the selected storage location of the document.
